(19) United States
(12) Patent Application Publication
(10) Pub. No.: US 2010/0163469 A1
(43) Pub. Date: Jul. 1, 2010

(54) CONTROL SYSTEM FOR MONITORING LOCALIZED CORROSION IN AN INDUSTRIAL WATER SYSTEM

(76) Inventors: Zhaoyang Wan, Yardley, PA (US); Gary Edwin Geiger, Richboro, PA (US); Glenn Alfred Johnson, Devon, PA (US); Brian Walter Lasiuk, Waukesha, WI (US)

Correspondence Address: General Electric Company;GE Global Patent Operation, 2 Corporate Drive, Suite 648, Shelton, CT, 06484, US

(21) Appl. No.: 12/344,324

(22) Filed: Dec. 26, 2008

(51) Int. Cl. C23F 11/00; C02F 1/00; G05D 21/00

(52) U.S. Cl. 210/96.1

(57) ABSTRACT

A control system is disclosed for monitoring and controlling localized corrosion in an industrial water system, comprising: measuring quantitative localized corrosion rate and at least one controllable water chemistry variable; identifying mathematical correlations between the quantitative localized corrosion rate and the at least one controllable water chemistry variable; establishing mathematical correlations between the controllable water chemistry variable and at least one chemical treatment feed; defining an index derived from current and future values of the localized corrosion rate and an index derived from current and future values of the at least one chemical treatment feed; utilizing a processor to minimize the index of the localized corrosion rate and the index of the at least one chemical treatment feed and determine current and future values of the at least one chemical treatment feed; and implementing only a current value of the at least one chemical treatment feed within the water system.

### FIELD OF THE INVENTION

The field of the invention relates to accumulation and analysis of real time data, and proactively maximizing localized corrosion inhibition while minimizing cost of water and treatment chemicals so as to result in a more effective and efficient industrial water system. In particular, it relates to system for monitoring and controlling localized corrosion in industrial water systems, such as but not limited to, cooling water systems, boiler systems, water reclamation systems, and water purification systems.

### BACKGROUND OF THE INVENTION

Abundant supplies of fresh water are essential to the development of industry. Enormous quantities are required for the cooling of products and equipment, for process needs, for boiler feed, and for sanitary and potable water supply. It is becoming increasingly apparent that fresh water is a valuable resource that must be protected through proper management, conservation, and use. In order to insure an adequate supply of high quality water for industrial use, the following practices must be implemented: (1) purification and conditioning prior to consumer (potable) or industrial use; (2) conservation (and reuse where possible); and/or (3) wastewater treatment.

The solvency power of water can pose a major threat to industrial equipment. Corrosion reactions cause the slow dissolution of metals by water and eventually structural failure of process equipment. Deposition reactions, which produce scale on heat transfer surfaces and which can cause both loss of energy efficiency and loss of production, represent a change in the solvency power of water as its temperature is varied. The control of corrosion and scale is a major focus of water treatment technology.

Typical industrial water systems are subject to considerable variation. The characteristics of water composition can change over time. The abruptness and degree of change depend upon the source of the water. Water losses from a recirculating system, changes in production rates, and chemical feed rates all introduce variation into the system and thereby influence the ability to maintain proper control of the system.

General corrosion is widespread and occurs on a relatively large scale or relatively large area. General corrosion is relatively uniform on the surface of a pipe or vessels in the target system, or on a sensor. General corrosion damages and removes metal mass, which changes the geometry, i.e., thickness of the surface, and causes a degradation or depletion of original material. General corrosion compromises the structural rigidity and integrity of a pipe or vessel. Exemplary general corrosion can include, but is not limited to, large-scale surface oxidation, e.g., to form metal oxides. On the other hand, localized corrosion may be widespread or limited to only a few areas of the target system, but is relatively non-uniform and occurs on a relatively small scale. Exemplary localized corrosion can include, but is not limited to, pitting, environmental stress cracking (ESC), (hydrogen) embrittlement, etc, as well as combinations thereof.

Typically, given a particular calcium ion content in water, a treatment comprised of an inorganic orthophosphate together with a water soluble polymer is used to form a protective film on metallic surfaces in contact with aqueous systems, in particular cooling water systems, to thereby protect such from corrosion. The water soluble polymer is critically important to control calcium phosphate crystallization so that relatively high levels of orthophosphate may be maintained in the system to achieve the desired protection without resulting in fouling or impeded heat transfer functions which normally are caused by calcium phosphate deposition. Water soluble polymers are also used to control the formation of calcium sulfate and calcium carbonate and additionally to dispense particulates to protect the overall efficiency of water systems.

U.S. Pat. No. 5,171,450 established a simplified recognition that the phenomenon of scaling or corrosion in cooling towers can be inhibited by selection of an appropriate polymer, or combination of polymers, as the treating agent. This was based on the fact that losses of the active polymer as a consequence of attrition due to protective film formation on equipment or avoiding deposits by adsorbing onto solid impurities to prevent agglomeration or crystal growth of particulates which can deposit on the equipment. In this patent, the active polymer is defined as the polymer measured by its fluorescent tags, and active polymer loss is defined by using an inert chemical tracer (measure of total product concentration) and subtracting active polymer concentration as indicated from tagged polymer level. Thus, the control of corrosion and scaling is accomplished by control of active polymer at a level where active component losses are not excessive.

The present inventors have noted that the controlled variables in U.S. Pat. No. 5,171,450 have no direct linkage to site specific key performance parameters such as corrosion and scaling. Every industrial water system is unique. In operating systems, proper treatment often requires constant adjustment of the chemistry to meet the requirements of rapidly changing system conditions. A suitable target of polymer loss or percent polymer inhibition efficiency for one system at a given time may not be suitable for the same system at a different time or for a different system. Without direct measurement of performance, polymer concentration monitoring provides no assurance for site specific performance.

U.S. Pat. Nos. 6,510,368 and 6,068,012 propose performance based control systems by directly measuring performance parameters such as corrosion, scaling and fouling on simulated detection surfaces. Although the proposed methods deal with some of the disadvantages of chemical treatment feedback control, such as monitoring an inert chemical tracer leads to control wind down of active chemicals and monitoring active chemicals leads to control wind up of total chemical feed, neither chemical monitoring methods provide assurance for site specific performance. In both 6,510,368 and 6,068,012, a decision tree was developed to identify from performance measurements the causes of performance degradation and take corrective actions accordingly.

Firstly, U.S. Pat. Nos. 6,510,368 and 6,068,012 use a Linear Polarization Resistance (LPR) corrosion probe, which only qualitatively detects pitting corrosion by instability of its corrosion measurements. These probes can neither specify a numeric value for the target for pitting corrosion control, nor quantify the deviation of current measurement from the target. Secondly, the qualitative measurement of pitting corrosion is only logically linked to one control action, i.e. increasing corrosion inhibitor feed, while in reality, there are many controllable water chemistry variables which can be used for alleviating corrosion. Thirdly, because both sensor measurements and logic for pitting corrosion control are qualitative, there is no way to determine whether control action is appropriate. Corrosion, scaling and fouling are highly inter-correlated. Once pitting corrosion commences, it will intensify corrosion, scaling and fouling altogether. A slow and low dosage increase of chemical treatment may never recover the system from its degradation. A delayed chemical treatment increase may demand three or four times more chemicals to bring the system back to its performance baseline, resulting in an uneconomical consumption of chemicals.

A need exists within the industry for a control system that maximizes localized corrosion inhibition and minimizes cost of water and treatment chemicals, resulting in a more efficient and economical processes.

### SUMMARY OF THE INVENTION

Disclosed is a control system that utilizes multiple measurements of information and models to decide optimal control actions in order to maximize localized corrosion inhibition and minimize cost of water and treatment chemicals. The system is capable of automatic operation for a wide range of process conditions, ensures multiple performance objectives, achieves robust operation under a variety of unmeasurable disturbances, and achieves the least costly solution delivery.

In one embodiment of the present invention, a control system is disclosed for monitoring and controlling localized corrosion in an industrial water system that is comprised of measuring quantitative localized corrosion rate and at least one controllable water chemistry variable; identifying mathematical correlations between the quantitative localized corrosion rate and the at least one controllable water chemistry variable; establishing mathematical correlations between the at least one controllable water chemistry variable and at least one chemical treatment feed; defining an index derived from current and future values of the localized corrosion rate and an index derived from current and future values of the at least one chemical treatment feed; at each sampling time, utilizing a processor to minimize the index of the localized corrosion rate and the index of the at least one chemical treatment feed, and determine current and future values of the at least one chemical treatment feed; and at each sampling time, implementing only a current value of the at least one chemical treatment feed within the water system.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1 is a demonstration of corrosion rates and corrosion inhibitor concentration versus time in accordance with one embodiment of the present invention;

FIG. 2 is a demonstration of corrosion rates versus corrosion inhibitor concentration in accordance with one embodiment of the present invention;

FIG. 3 is a control system structure in accordance with one embodiment of the present invention; and

FIG. 4 is a fuzzy logic model correlating corrosion/deposition tendency with corrosion/deposition inhibitors in accordance with one embodiment of the present invention.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The present invention discloses a control system that utilizes multiple measurements of information and models to decide optimal control actions in order to maximize localized corrosion inhibition and minimize cost of water and treatment chemicals. The system is capable of automatic operation for a wide range of process conditions, ensures multiple performance objectives, achieves robust operation under a variety of unmeasurable disturbances, and achieves the least costly solution delivery.

Corrosion can be defined as the destruction of a metal by a chemical or electrochemcial reaction with its environment. The formation of anodic and cathodic sites, necessary to produce corrosion, can occur for any of a number of reasons including, but not limited to: impurities in the metal, localized stresses, metal grain size or composition differences, discontinuities on the surface, and differences in the local environment (e.g., temperature, oxygen, or salt concentration). When these local differences are not large and the anodic and cathodic sites can shift from place to place on the metal surface, corrosion is uniform. Localized corrosion, which occurs when the anodic sites remain stationary, is a more serious industrial problem. Forms of localized corrosion include pitting, selective leaching (e.g. dezincification), galvanic corrosion, crevice or underdeposit corrosion, intergranular corrosion, stress corrosion, cracking, and microbiologically influenced corrosion.

Certain conditions, such as low concentrations of oxygen or high concentrations of species such as chloride which compete as anions, can interfere with a given alloy's ability to re-form a passivating film. In the worst case, almost all of the surface will remain protected, but tiny local fluctuations will degrade the oxide film in a few critical points. Corrosion at these points will be greatly amplified, and can cause corrosion pits of several types, depending upon conditions. While the corrosion pits only nucleate under fairly extreme circumstances, they can continue to grow even when conditions return to normal, since the interior of a pit is naturally deprived of oxygen and locally the pH decreases to very low values and the corrosion rate increases due to an auto-catalitic process. In extreme cases, localized corrosion can cause stress concentration to the point that otherwise tough alloys can shatter, or a thin film pierced by an invisibly small hole can hide a thumb sized pit from view. These problems are especially dangerous because they are difficult to detect before a part or structure fails.

In one embodiment of the present invention, a control system is disclosed for monitoring and controlling localized corrosion in an industrial water system that measures quantitative localized corrosion rate and at least one controllable water chemistry variable; identifies mathematical correlations between the quantitative localized corrosion rate and the at least one controllable water chemistry variable; establishes mathematical correlations between the at least one controllable water chemistry variable and at least one chemical treatment feed; and defines an index derived from current and future values of the localized corrosion rate and an index derived from current and future values of the at least one chemical treatment feed variable. At each sampling time, the control system then utilizes a processor to minimize the index of the localized corrosion rate and the index of the at least one chemical treatment feed, and determines current and future values of the at least one chemical treatment feed, and the implements a current value of the at least one chemical treatment feed within the water system. Although current and future values of the at least one chemical treatment feed are computed, the controller implements only the first computed value of the at least one chemical treatment feed, and repeats these calculations at the next sampling time.

The control system can be used over a variety of different industrial water systems, including, but not limited to, a recirculating system, a cooling tower system, and a boiler system.

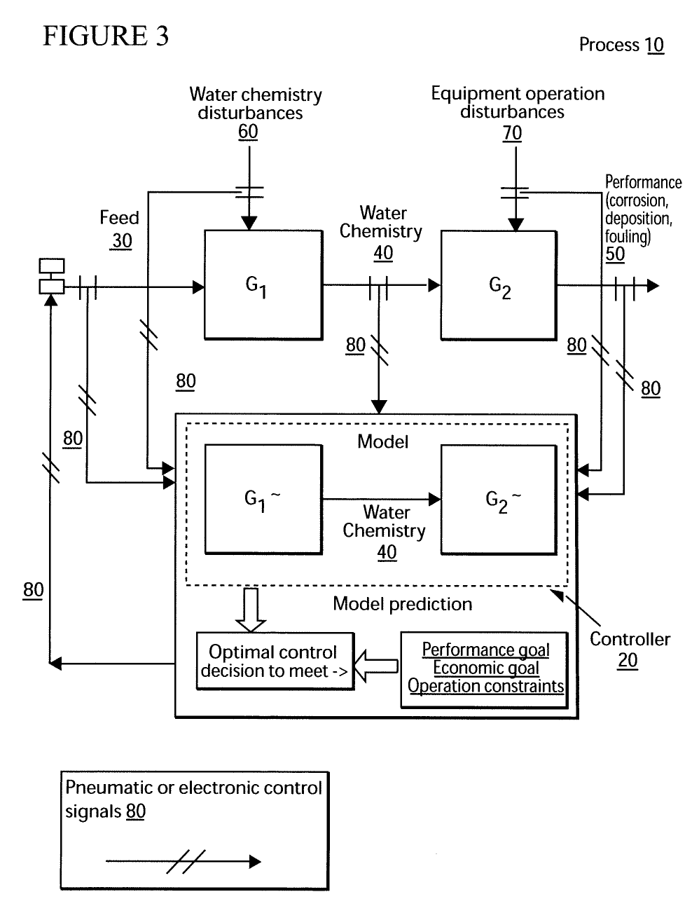

An embodiment of the presently claimed control system is based on a comprehensive view of an industrial water system and its control structure. FIG. 3 shows a control system structure according to one embodiment of the present invention. An industrial water treatment process 10 is connected to a controller 20. Within the process 10, G1 is the transfer function from chemical treatment feed 30 to water chemistry 40, and G2 is the transfer function from water chemistry 40 to localized corrosion 50. Within the controller 20, G1˜ is the perceived transfer function from chemical feed 30 to water chemistry 40, and G2˜ is the perceived transfer function from water chemistry 40 to localized corrosion 50. The closer G1˜ and G2˜ in the controller 20 approximate G1 and G2 in the process 10, the better the control objective of minimizing localized corrosion 50 and chemical feed 30 can be achieved.

As shown in FIG. 3, the inputs of the water treatment process 10 are chemical feeds 30, water chemistry disturbances 60 and equipment operation disturbances 70. The output of the water treatment process 10 and thus the input of the controller 20 are measurements of chemical feed 30, water chemistry 40, performance 50, and water chemistry disturbances 60 and equipment operation disturbances 70. The output of the controller 20 is chemical treatment feed 30. The controller provides both feedback and feedforward compensation for water chemistry disturbances 60 and equipment operation disturbances 70 as they occur to maximize asset protection and minimize chemical usage. Pneumatic or electronic control signals 80 represent the signals sent from sensors to the controller and the signals sent from the controller to feed pumps.

In an embodiment of the present invention, the localized corrosion rate is measured by a multi-electrode array (MEA) pitting corrosion sensor. A multi-electrode array (MEA) is a passive detector, similar to a wire beam electrode (WBE) that measures both local and general corrosion rates simultaneously. One example of a multi-electrode array (MEA) pitting corrosion sensor is the nanoCorr pitting corrosion sensor, a commercial MEA device from Corr Instruments, LLC.

The nanoCorr MEA is an electronic device, which measures the temporal and spatial distribution of the anodic and cathodic regions on a segmented metallic electrode structure. The segmentation enables the measurement of both half-cell reactions in the corrosion process simultaneously:

M→M⁺+e⁻ (1)

O₂+2H₂O+4e⁻→4OH⁻ (2)

The magnitude of the current flowing in each of the electrodes can be used to calculate both the local and general corrosion rate. The current is related to the corrosion rate (CR) via the formula:

$$CR = \frac{{W}_{e} {I}^{c}}{ɛρ AF} \qquad ( 3 )$$

where Wₑ is the effective molecular weight of the electrode material, I^{e} is a characteristic anodic current measured from the electrodes, ε is a current distribution factor, ρ is the electrode material density, A is the exposed surface area of the electrode, and F is the Faraday constant. The general corrosion rate can be estimated by using the average anodic current for I^{c} while the local corrosion rate utilizes the maximum anodic current for I^{c}.

Integrating the corrosion rate over a specific time interval allows an estimation of the penetration depth due to a specific corrosion process. For example the maximum pitting depth can be estimated by:

$${d}_{pitting} = \frac{{W}_{e}}{ɛρ AF} \int {I}_{max} d t \qquad ( 4 )$$

Conversely, the average anodic current in equation (4) gives the penetration depth due to general corrosion.

A multi-electrode array (MEA) pitting corrosion sensor gives quantitative localized corrosion rate measurements, so that a quantitative mathematical model can be established between quantitative localized corrosion rate and various water chemistry variables, enabling a control algorithm, based on quantitative model, to make the corrective action at the right time and right amount.

In one embodiment of the present invention, the at least one controllable water chemistry variables are comprised of variables such as pH, cycle of concentration, concentration of calcium, magnesium, inorganic phosphoric acids, phosphonic acid salts, organic phosphoric acid esters, and polyvalent metal salts, copper corrosion inhibitor, phosphinosuccinate oligomers, water soluble polymers, and combinations thereof.

Examples of such inorganic phosphoric acids include condensed phosphoric acids and water soluble salts thereof. The phosphoric acids include an orthophosphoric acid, a primary phosphoric acid and a secondary phosphoric acid. Inorganic condensed phosphoric acids include polyphosphoric acids such as pyrophosphoric acid, tripolyphosphoric acid and the like, metaphosphoric acids such as trimetaphosphoric acid, and tetrametaphosphoric acid.

As to the other phosphonic acid derivatives which are to be added in addition to the polymers of the present invention, there may be mentioned aminopolyphosphonic acids such as aminotrimethylene phosphonic acid, ethylene diaminetetramethylene phosphonic acid and the like, methylene diphosphonic acid, hydroxyethylidene diphosphonic acid, 2-phosphonobutane 1,2,4, tricarboxylic acid, etc.

Exemplary organic phosphoric acid esters which may be combined with the polymers of the present invention include phosphoric acid esters of alkyl alcohols such as methyl phosphoric acid ester, ethyl phosphoric acid ester, etc., phosphoric acid esters of methyl cellosolve and ethyl cellosolve, and phosphoric acid esters of polyoxyalkylated polyhydroxy compounds obtained by adding ethylene oxide to polyhydroxy compounds such as glycerol, mannitol, sorbitol, etc. Other suitable organic phosphoric esters are the phosphoric acid esters of amino alcohols such as mono, di, and tri-ethanol amines.

Inorganic phosphoric acid, phosphonic acid, and organic phosphoric acid esters may be salts, preferably salts of alkali metal, ammonia, amine and so forth Exemplary polyvalent metal salts which may be combined with the water soluble polymers of the invention include those capable of dissociating polyvalent metal cations in water such as Zn++, Ni++, etc., which include zinc chloride, zinc sulfate, nickel sulfate, nickel chloride and so forth.

The water soluble polymer may be an acrylic acid copolymer formed by polymerization of acrylic acid with allyloxy monomers. The objective is an aqueous solution polymerization process for the preparation of water-soluble or water dispersible polymers having the formula depicted in Formula I below:

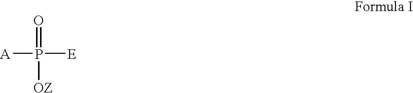

wherein A is a random polymeric residual comprising at least one unit of Formula II below:

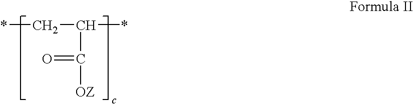

and at least one unit of Formula III below:

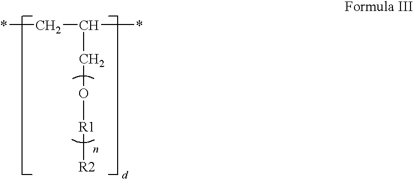

and E is hydrogen, OZ, a residue A, or mixtures thereof, wherein segment R1 is —CH₂—CH₂—, —CH₂—CH(CH₃)—, —CH₂—CH(OH)—, —CH₂—CH(OH)—CH₂—, or mixtures thereof, R2 is OH, SO₃Z, OSO₃Z, PO₃Z₂, OPO₃Z₂, CO₂Z, or mixtures thereof; n ranges from 1 to 100; Z is hydrogen or a water soluble cation such as Na, K, Ca or NH₄; the molar ratio c:d ranges from 30:1 to 1:20; with the proviso that greater than 75 mole percent of the hypophosphorous acid utilized in the synthesis of said copolymer incorporates into the polymer matrix

In a preferred embodiment, R1 is —CH₂—CH₂—, —CH₂—CH(OH)—CH₂—, or mixtures thereof; R2 is OH, SO₃Z, OSO₃Z or mixtures thereof, n ranges from 1 to 20; Z is hydrogen or a water soluble cation such as Na, K, or NH₄; the molar ratio c:d ranges from 15:1 to 1:10; with the proviso that greater than 75 mole % of the hypophosphorous acid utilized in the synthesis of said copolymer incorporates into the polymer matrix.

In a particularly preferred embodiment of the invention R1 is —CH₂—CH₂—; R2 is OSO₃Z; n ranges from 5 to 20; Z is hydrogen or a water soluble cation such as Na, K, or NH₄; the molar ratio c:d ranges from 15:1 to 2:1; with the proviso that greater than 85 mole % of the hypophosphorous acid utilized in the synthesis of said polymer incorporates into the polymer matrix.

In addition, water soluble azole compounds can be used in combination with the water soluble polymers. Such azoles have the formula below:

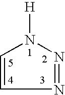

Included within the scope of the invention are N-alkyl substituted 1,2,3-triazole, or a substituted water soluble 1,2,3-triazole where substitution occurs at the 4 and/or 5 position of the ring. The preferred 1,2,3-triazole is 1,2,3-tolyltriazole of the formula below:

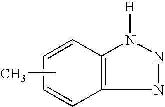

Other exemplary 1,2,3-triazoles include benzotriazole, 4-phenol-1,2,3-triazole, 4-methyl-1,2,3-triazole, 4-ethyl-1,2,3-triazole, 5 methyl-1,2,3-triazole, 5-ethyl-1,2,3-triazole, 5-propyl-1,2,3-triazole, and 5-butyl-1,2,3-triazole. Alkali metal or ammonium salts of these compounds may be used.

Other azole compounds include thiazole compounds of the formula below:

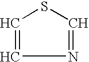

Suitable thiazoles include thiazole, 2-mercaptothiazole, 2-mercaptobenzothiazole, benzothiazole and the like.

The copper corrosion inhibitors comprise non-halogenated, substituted benzotriazoles selected from the group consisting of: 5,6-dimethyl-benzotriazole; 5,6-diphenylbenzotriazole; 5-benzoyl-benzotriazole; 5-benzyl-benzotriazole and 5-phenyl-benzotriazole.

There exists non-halogenated, nitrogen containing, aromatic compounds that are effective copper corrosion inhibitors for aqueous systems being treated with halogen. The corrosion inhibiting materials are those nitrogen containing, aromatic compounds which provide copper corrosion inhibition in aqueous systems comparable to tolyltriazole in the absence of halogen; copper corrosion of less than about 2.5 mills per year in aqueous systems where halogen is present; and do not exhibit a detrimental effect on halogen demand in the system being treated. The nitrogen containing, aromatic compounds which were found to be effective copper corrosion inhibitors in the presence of halogen in an aqueous system did not fall within any readily discemable chemical class. Accordingly, those materials which meet this criteria shall hereinafter be classified as “halogen resistant copper corrosion inhibitors” (HRCCI). HRCCI materials, exemplified by non-halogenated, nitrogen containing, aromatic materials, provide effective, halogen resistant corrosion inhibition in aqueous system being treated with halogen.

In treating an aqueous system with HRCCI materials, HRCCI is preferably fed continuously to the water. A preferred treatment concentration ranges from about 0.2 to 10 parts per million. Continuous feed is not, however, a requirement. The HRCCI materials can be fed at a concentration sufficient to form a protective film and thereafter feed can be discontinued for extended periods of time. The HRCCI materials may be employed in combination with other conventional water treatment materials, including different corrosion inhibitors, as well as surfactants, scale inhibitors, dispersants, pH adjusters and the like.

The water soluble polymers may also be used in conjunction with molybdates such as, inter alia, sodium molybdate, potassium molybdate, lithium molybdate, ammonium molybdate, etc.

The polymers may be used in combination with yet other topping agents including corrosion inhibitors for iron, steel, copper, copper alloys or other metals, conventional scale and contamination inhibitors, metal ion sequestering agents, and other conventional water treating agents. Other corrosion inhibitors comprise tungstate, nitrites, borates, silicates, oxycarboxylic acids, amino acids, catechols, aliphatic amino surface active agents, benzotriazole, and mercaptobenzothiazole. Other scale and contamination inhibitors include lignin derivatives, tannic acids, starch, polyacrylic soda, polyacrylic amide, etc. Metal ion sequestering agents include polyamines, such as ethylene diamine, diethylene triamine and the like and polyamino carboxylic acids, such as nitrilo triacetic acid, ethylene diamine tetraacetic acid, and diethylene triamine pentaacetic acid.

In one embodiment of the present invention, the at least one chemical treatment feed is comprised of variables such as acid, caustic, corrosion inhibitor, deposition inhibitor, biocide, and combinations thereof.

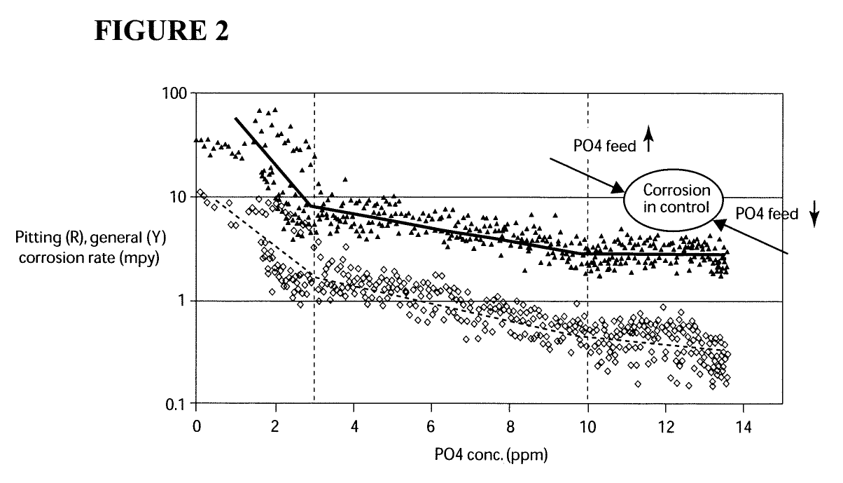

In another embodiment, the mathematical correlation between the quantitative localized corrosion rate and the at least one controllable water chemistry variable is steady state statistic correlations. FIG. 2 demonstrates corrosion rates versus corrosion inhibitor concentration according to an embodiment of the invention. When PO₄ concentration equals 10 ppm, corrosion starts to increase. When PO₄ concentration equals a threshold of 3 ppm, corrosion increases dramatically. A steady state mathematical correlation between localized corrosion rate and PO₄ concentration (log10(Corrosion)=f(PO4)) can be derived from FIG. 2, in the form of a lookup table, as shown below in Table 1, a chart, or a piecewise linear equation. For such a piecewise linear equation:

$$\frac{{log}_{10} ( CorrosionRate )}{[ {PO}_{4} ]} = \{ \begin{matrix}0.4 , & if [ {PO}_{4} ] < 3 ppm \\ 0.07 , & if 3 \leq [ {PO}_{4} ] \leq 10 ppm \\ 0. & if [ {PO}_{4} ] > 10 ppm\end{matrix}$$

TABLE 1

| | | Log10 |
|---|---|---|
| PO₄ | | (Corrosion rate)/ |
| Concentration | | ppm PO4 |
| <3 | ppm | 0.4 |
| 3-10 | ppm | 0.07 |
| >10 | ppm | 0 |

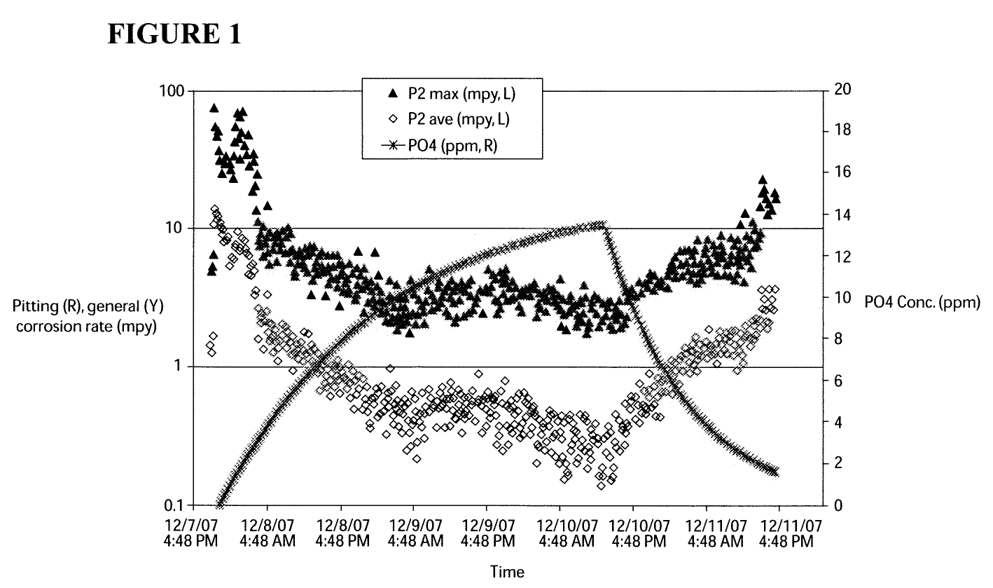

In an alternate embodiment, the mathematical correlation between the quantitative localized corrosion rate and the at least one controllable water chemistry variable is dynamic statistic correlations over the time. FIG. 1 is a demonstration of corrosion rates and corrosion inhibitor concentration versus time in accordance with one embodiment of the present invention. FIG. 1 is an illustration of one multi-electrode array (MEA) pitting corrosion sensor probe according to an embodiment of the invention, where “max” represent pitting (or localized) corrosion and “ave” represent general corrosion. As corrosion inhibitor PO₄ concentration increases from 0 ppm to 14 ppm, corrosion rates are suppressed. As corrosion inhibitor PO₄ concentration decreases from 14 ppm to 0 ppm, both the local and general corrosion rates increase. Localized corrosion rates increase faster than general corrosion rates. A dynamic mathematical correlation between localized corrosion rate and PO₄ concentration (log10(corrosion rate)=f(PO₄, time) can be derived from FIG. 1, in the form of a lookup table as shown below in Table 2, a chart, or a piecewise linear equation. For such a piecewise linear equation:

$$\frac{d \{ {log}_{10} ( CorrosionRate ) \}}{d t} = \{ \begin{matrix}0.4 * [ {PO}_{4} ] - {log}_{10} ( CorrosionRate ) , & if [ {PO}_{4} ] < 3 ppm \\ 0.07 * [ {PO}_{4} ] - {log}_{10} ( CorrosionRate ) , & if 3 \leq [ {PO}_{4} ] \leq 10 ppm \\ 0 * [ {PO}_{4} ] - {log}_{10} ( CorrosionRate ) . & if [ {PO}_{4} ] > 10 ppm\end{matrix}$$

TABLE 2

| PO₄ | | |
|---|---|---|
| Concentration | | d{Log10 (Corrosion rate)}/dt |
| <3 | ppm | 0.4 * [ppm PO4] − Log10 {Corrosion rate} |
| 3-10 | ppm | 0.07 * [ppm PO4] − Log10 {Corrosion rate} |
| >10 | ppm | 0 * [ppm PO4] − Log10 {Corrosion rate} |

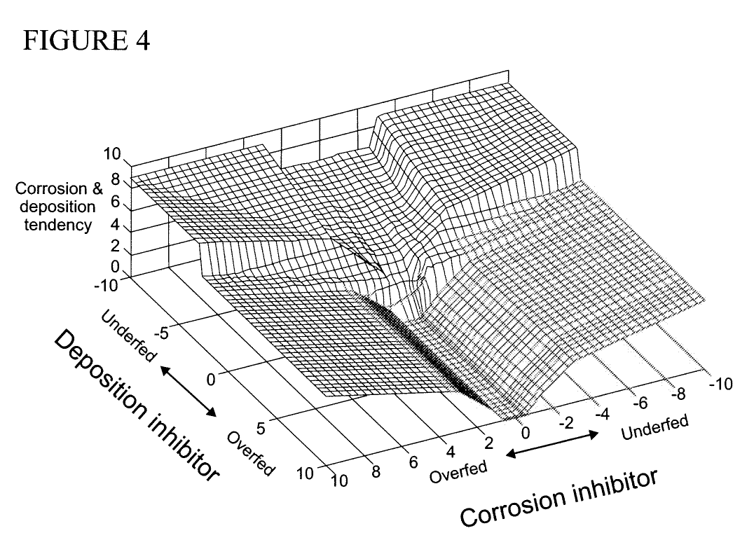

In one embodiment of the present invention, based on experiments or experience, the mathematical correlations between the quantitative localized corrosion rate and the at least one controllable water chemistry variable are identified in lookup tables or charts, which specify ranges of the at least one controllable water chemistry variable and corrosion and deposition tendencies. These lookup tables or charts are stored in the controller. As shown FIG. 4, a fuzzy logic model correlates corrosion and deposition tendencies with different ranges of corrosion inhibitor and deposition inhibitor feed. Both overfeed and underfeed of corrosion inhibitors may lead to less corrosion and deposition protection. Underfeed of deposition inhibitors may lead to less corrosion and deposition protection, but overfeed of deposition inhibitors does not have much adverse effect on corrosion and deposition protection. This is a visualization of the ratings of corrosion and deposition tendencies assigned to different treatment conditions by a group of experts.

In an alternate embodiment, the fuzzy logic model may be presented in lookup table format.

A mass balance model for a chemical species X can be expressed as the amount of X accumulated in the system equals to the amount of X entering the system minus the amount of X leaving the system. The mathematical formula for such is:

$$V \frac{d C ( t )}{d t} = - B ( t ) \cdot C ( t ) + F ( t )$$

where V is system volume, B is blowdown flow, F is chemical feed flow, C is concentration of chemical species X in the system. Using a sampling time of Δt and Euler's first order approximation for the derivative, i.e.

$$\frac{d C ( t )}{d t} \approx \frac{C ( t + 1 ) - C ( t )}{Δ t} ,$$

the mass balance model can be expressed as C(t+1)=f(C(t), F(t), B(t)), i.e. chemical concentration (measured output) at time t+1 is a function of chemical concentration (measured output), chemical feed (manipulated variable) and blowdown (measured disturbance) at time t. If blowdown is constant, the model becomes:

$$τ \frac{d C ( t )}{d t} = - C ( t ) + {C}_{ss} \cdot \% pumpOpen ( t )$$

where τ(=V/B) is system time constant, % pumpOpen is the percentage opening of a pump, Css(=F/B) is steady state concentration if % pumpOpen equals to 100%.

In one embodiment, the control system defines an index as a summation of current and future values of the localized corrosion rate and an index as a summation of current and future values of the at least one chemical treatment feed. In another embodiment, at each sampling time, the control system minimizes the index of the localized corrosion rate and the index of the at least one chemical treatment feed, and determines current and future values of the at least one chemical treatment feed.

Although current and future values of the at least one chemical treatment feed are computed, the controller implements only the first computed values of the at least one chemical treatment feed, and repeats these calculations at the next sampling time. The mathematical formula for such is that at sampling time to, solve:

$${min}_{Feed ( t )} {\sum }_{t = {t}_{0}}^{{t}_{0} + N} \{ [ Corr ( t ) ] + [ Feed ( t ) ] \}$$

subject to:

Corr(t+1)=f(WaterChem(τ),τ≦t)

WaterChem(t)=g(Feed(t))

t=t₀ . . . t₀+N

where t₀ is current time, t₀+N is the N step ahead in future. Current values of localized corrosion rate Corr(t) and controllable water chemistry variable WaterChem(t) are measured, while future values of localized corrosion rate Corr(t+i), i>0 and controllable water chemistry variable WaterChem(t+i), i>0 are predicted based on current and future feed Feed(t+i), i>=0 by the mathematically correlations between chemical feeds and controllable water chemistry variables, and between controllable water chemistry variables and localized corrosion rate. The current and future feed Feed(t+i), i>=0 are determined by solving the optimization.

In an alternate embodiment, the control system, at each sampling time, implements current value of the at least one chemical treatment feed within the water system.

In one embodiment, the mathematical correlation is generated from data by using least square method.

The method of least squares is used to solve overdetermined systems. Least squares is often applied in statistical contexts, particularly regression analysis. Least squares can be interpreted as a method of fitting data. The best fit in the least-squares sense is that instance of the model for which the sum of squared residuals has its least value, a residual being the difference between an observed value and the value given by the model. Least squares corresponds to the maximum likelihood criterion if the experimental errors have a normal distribution and can also be derived as a method of moments estimator. The method of least squares assumes that the best-fit curve of a given type is the curve that has the minimal sum of the deviations squared (least square error) from a given set of data. If the data points are (x₁,y₁), (x₂,y₂), . . . (xₙ,yₙ) where x is the independent variable and y is the dependent variable. The fitting curve f(x) has the deviation (error) d from each data point, i.e., d₁=y₁−f(x₁), d₂=y₂−f(x₂), . . . , dₙ=yₙ−f(xₙ). According to the method of least squares, the best fitting curve has the property that:

$$II = {d}_{1}^{2} + {d}_{2}^{2} + … + {d}_{n}^{2} = {\sum }_{t = 1}^{n} {d}_{t}^{2} = {\sum }_{t = 1}^{n} {[ {y}_{t} - f ( {x}_{t} ) ]}^{2} = a minimum$$

In another embodiment, the mathematical correlation is generated from data by artificial neural network (ANN) or fuzzy logic methods.

An artificial neural network (ANN), often called a “neural network” (NN), is a mathematical model or computational model based on biological neural networks. It consists of an interconnected group of artificial neurons and processes information using a connectionist approach to computation.

Fuzzy logic is a form of multi-valued logic derived from fuzzy set theory to deal with reasoning that is approximate rather than precise. Just as in fuzzy set theory the set membership values can range (inclusively) between 0 and 1, in fuzzy logic the degree of truth of a statement can range between 0 and 1 and is not constrained to the two truth values {true, false} as in classic predicate logic.With fuzzy logic, an element can partially belong to multiple classes. For any two fizzy sets (S1 and S2), three basic operations can be defined:
Intersection: μ_{S1∩S2}=min{μ_{S1}(u), μ_{S2}(u)}
Union: μ_{S1∩S2}=max{μ_{S1}(u), μ_{S2}(u)}
Complement: μ_{S1}=1−μ_{S1}

Therefore, the key improvements to the above performance based control systems are that (1) use of quantitative pitting corrosion measurements, such that a numeric value can be specified as pitting corrosion control target and deviation of system pitting corrosion rate from its target can be quantified; (2) quantitative mathematical models correlating multiple controllable water chemistry variables to pitting corrosion rate; (3) quantitative mathematical models correlating multiple controllable water chemistry variables to multiple chemical treatment feeds; and (4) control algorithms which, based on the models, minimizes both localized corrosion rate and cost of chemical treatment feeds.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. A control system for monitoring and controlling localized corrosion in an industrial water system comprising:
a) measuring quantitative localized corrosion rate and at least one controllable water chemistry variable;
b) identifying mathematical correlations between the quantitative localized corrosion rate and the at least one controllable water chemistry variable;
c) establishing mathematical correlations between the at least one controllable water chemistry variable and at least one chemical treatment feed;
d) defining an index derived from current and future values of the localized corrosion rate and an index derived from current and future values of the at least one chemical treatment feed;
e) at each sampling time, utilizing a processor to minimize the index of the localized corrosion rate and the index of the at least one chemical treatment feed and determining current and future values of the at least one chemical treatment feed; and
f) at each sampling time, implementing current value of the at least one chemical treatment feed within the water system.

2. The control system of claim 1 wherein the industrial water system is a recirculating system.

3. The control system of claim 2 wherein the industrial water system is a cooling tower system or a boiler system.

4. The control system of claim 1 wherein the localized corrosion rate is measured by a multi-electrode array (MEA) pitting corrosion sensor.

5. The control system of claim 1 wherein the at least one controllable water chemistry variable is comprised of pH, cycle of concentration, concentration of calcium, magnesium, inorganic phosphoric acids, phosphonic acid salt, organic phosphoric acid esters, polyvalent metal salts, copper corrosion inhibitor, phosphinosucciniate oligomers, water soluble polymers, and combinations thereof

6. The control system of claim 5 wherein the copper corrosion inhibitor comprises non-halogenated, substituted benzotriazoles selected from the group consisting of: 5,6-dimethyl-benzotriazole; 5,6-diphenylbenzotriazole; 5-benzoyl-benzotriazole; 5-benzyl-benzotriazole and 5-phenyl-benzotriazole.

7. The control system of claim 5 wherein the water soluble polymer is an acrylic acid copolymer formed by polymerization of acrylic acid with allyloxy monomers.

8. The control system of claim 1 wherein the at least one chemical treatment feed is comprised of acid, caustic, corrosion inhibitor, deposition inhibitor, biocide, and combinations thereof.

9. The control system of claim 1 wherein the mathematical correlation is lookup tables which specify ranges of the at least one controllable water chemistry variable and their percentage of corrosion inhibition neutral and alkaline pH water treatment programs.

10. The control system of claim 9 wherein the mathematical correlation is steady state statistic correlations between quantitative localized corrosion rate and the at least one controllable water chemistry variable.

11. The control system of claim 9 wherein the mathematical correlation is dynamic statistic correlations between quantitative localized corrosion rate and the at least one controllable water chemistry variable over the time.

12. The control system of claim 1 wherein the mathematical correlation is generated from data by using least square method.

13. The control system of claim 1 wherein the mathematical correlation is generated from data by artificial neural network (ANN) and/or fuzzy logic methods.

14. The control system of claim 1 wherein the mathematical correlations are defined and stored in a processor.

15. The control system of claim 1 wherein the indexes are defined and stored in a processor.

16. The control system of claim 1 wherein the minimization is performed in a processor.
